(19) United States
(12) Patent Application Publication
(10) Pub. No.: US 2023/0176455 A1
(43) Pub. Date: Jun. 8, 2023

(54) Spatial Imaging Devices and Methods

(71) Applicant: Ironview 360 LLC, Aurora, CO (US)

(72) Inventor: Timur R Urmeyev, Aurora, CO (US)

(21) Appl. No.: 17/963,846

(22) Filed: Oct. 11, 2022

Related U.S. Application Data
(60) Provisional application No. 63/253,774, filed on Oct. 8, 2021.

(51) Int. Cl. G03B 17/56; H04N 23/56; G03B 15/05

(52) U.S. Cl. CPC G03B 17/561; H04N 23/56; G03B 15/05

(57) ABSTRACT

The present disclosure generally relates to specialized light sources, systems, and methods for acquiring virtual tour data. In an embodiment, the systems and methods relate to spatial imaging for producing two-dimensional or three-dimensional virtual tour data at a rate of about 150,000 square feet per hour.

### CROSS-REFERENCE TO RELATED APPLICATIONS

This application claims the benefit of and priority to U.S. Provisional Patent Application No. 63/253,774, filed Oct. 8, 2021, which is hereby incorporated by reference in its entirety.

### STATEMENT REGARDING FEDERALLY SPONSORED RESEARCH

None.

### BACKGROUND

Virtual tour data is used today by those advertising buildings, places and services, such as homes for sale, hotel facilities, virtual exercise routes, and mixed-reality or augmented-reality experiences. In addition, contractors are using virtual tours to show construction progress and to document construction details that will become hidden at a later stage of construction. Such virtual records may, for example, be used to provide proof of workmanship, to defend insurance claims, or to locate in-wall components that need to be accessed or avoided at a later time.

However, capturing virtual tour data has historically required significant time and effort, at least partially because of the need to move the camera and lighting equipment to capture each angle of a location. In addition, the wide field-of-view of a three-dimensional camera or video recorder makes it difficult for a person or machine to interact with the camera/recorder without being seen in the images and/or obstructing portions of the environment, and editing an entire set of images to remove the person or machine is impractical. Thus, there is a need for technology that can solve challenges faced by the expanding field of virtual tour data acquisition.

### SUMMARY

The present disclosure generally relates to specialized light sources, systems, and methods for acquiring virtual tour data. In an embodiment, the systems and methods disclosed herein relate to spatial imaging for producing two-dimensional or three-dimensional virtual tour data at a rate of about 150,000 square feet per hour. Generally, the imaging is carried out in buildings and structures, such as structures that are under construction.

In an aspect, a light source comprises a male connector configured to thread into a light bulb socket, a body extending from the male connector that emits electromagnetic radiation in a 360 degree cylindrical pattern, and a mounting device at an opposite end of the body from the male connector.

In an embodiment, the light source further comprises a blackout disk disposed between the body and the mounting device. In an embodiment, a diameter of the blackout disk is about 7.5 cm.

In an embodiment, the blackout disk is a self-supporting object, such as a metal or plastic disk, or a coating, such as a black coating or dark paint on an end of a light body.

In an embodiment, the mounting device of the light source is a threaded post. In an embodiment, a mounting device comprises a plurality of legs configured to join with a device to be held by the mounting device.

In an aspect, a device for capturing virtual tour data comprises a swing arm mounted to a mobile unit, a light source of the type disclosed herein mounted at a distal end of the swing arm, and a camera attached to the mounting device.

In an embodiment, a device for capturing virtual tour data further comprises a blackout disk disposed between the body of the light source and the mounting device. For example, when the device is in use, the mounting device may extend substantially horizontal to a ground surface.

In an embodiment, the swing arm comprises at least four pivot points. In an embodiment, at least two of the four pivot points may rotate around axes oriented substantially perpendicular to one another. In an embodiment, at least three of the at least four pivot points may rotate around axes substantially perpendicular to a ground surface when the device is in use. In an embodiment, at least one of the at least four pivot points rotates around an axis substantially parallel to a ground surface when the device is in use.

In an embodiment, a mobile unit is a vest to be worn by a user, a helmet to be worn by a user, a manned or un-manned (i.e., autonomous) wheeled vehicle, or a manned or un-manned aerial vehicle.

In an embodiment, a device for capturing virtual tour data further comprises a gyroscope, which may be an independent component or a component disposed within the camera. For example, a gyroscope that is an independent component may be secured to the mounting device between the light source, or blackout disk, and the camera.

In an embodiment, a camera is a 2D camera for acquiring still images, a 3D camera for acquiring still images, or a 2D or 3D video camera. In an embodiment, an image or frame may be associated with a geospatial coordinate, which may be provided by a global positioning system (GPS). For example, a GPS may be an independent component or a sub-component of another component of a device for capturing virtual tour data or associated mobile unit.

In an embodiment, a longitudinal axis through the mounting device extends through a center point of a shutter within the camera.

In an embodiment, a processor of the camera operably communicates with a data storage system. For example, the data storage system may be local or remote to the device for capturing virtual tour data. Suitable local data storage systems include but are not limited to an external hard drive, a memory stick (thumb drive), or a memory card within a camera. Suitable remote storage systems include but are not limited to an off-site server or a cloud storage system. In an embodiment, image data captured by the camera is uploaded to the data storage system in real time.

In an embodiment, a device for capturing virtual tour data further comprises a battery pack providing power to the light source, the camera and/or a data storage system.

In an aspect, a method of capturing virtual tour data comprises: providing a swing arm mounted to a mobile unit, a light source as disclosed herein mounted at a distal end of the swing arm, and a camera attached to the mounting device; illuminating the light source; and capturing images using the camera while the mobile unit moves behind the camera throughout a physical location. In an embodiment, the step of capturing images occurs continuously or intermittently.

In an embodiment, an area is imaged at a rate of at least 50,000 square feet per hour, or at least 100,000 square feet per hour, or at least 150,000 square feet per hour. In an embodiment, an area is imaged at a rate between 50,000 and 1,500,000 square feet per hour, or between 75,000 and 1,000,000 square feet per hour, or between 100,000 and 750,000 square feet per hour, or between 125,000 and 500,000 square feet per hour, or between 125,000 and 250,000 square feet per hour, or between 125,000 and 200,000 square feet per hour, or between 125,000 and 175,000 square feet per hour.

### BRIEF DESCRIPTION OF THE DRAWINGS

Illustrative embodiments of the present invention are described in detail below with reference to the attached drawings, wherein:

FIG. 1 is a photograph of a light source, according to an embodiment;

FIG. 2 is a photograph showing a side view of the light source of FIG. 1 attached to a distal end of a device for capturing virtual tour data, according to an embodiment;

FIG. 3 is a photograph showing a side view of the light source of FIG. 1, with internal cabling running through the device, except at pivot points, according to an embodiment;

FIG. 4 is a photograph showing a perspective end view of the light source of FIG. 1 attached to a distal end of a device for capturing virtual tour data, according to an embodiment;

FIG. 5 and FIG. 6 are photographs showing side views of a device for capturing virtual tour data, according to an embodiment;

FIG. 7 is a photograph showing a front view of a device for capturing virtual tour data, according to an embodiment;

FIG. 8 is a photograph showing details of the front of a vest having a device for capturing virtual tour data mounted thereon, according to an embodiment;

FIG. 9 is a photograph showing details of an attachment mechanism for mounting a device for capturing virtual tour data on a vest and two proximal pivot points, according to an embodiment;

FIG. 10 is a photograph showing details of the back of a vest having a device for capturing virtual tour data mounted thereon, according to an embodiment;

FIG. 11 is a photograph showing a partial side view of a device for capturing virtual tour data mounted on a vest, according to an embodiment;

FIGS. 12, 13, 14 and 15 are photographs showing pivots points of a device for capturing virtual tour data, according to an embodiment; and

FIG. 16 is a photograph of a device for capturing virtual tour data in a compact configuration, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

A “device” is a combination of components operably connected to produce one or more desired functions.

A “component” is used broadly to refer to an individual part of a device.

“Proximal” and “distal” refer to the relative positions of two or more objects, planes or surfaces. For example, an object that is close in space to a reference point relative to the position of another object is considered proximal to the reference point, whereas an object that is further away in space from a reference point relative to the position of another object is considered distal to the reference point.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third component).

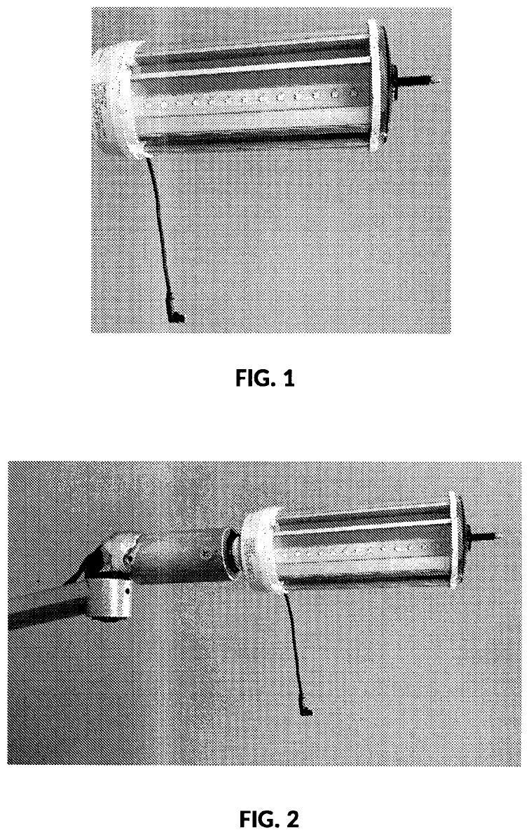

FIG. 1 is a photograph of a light source comprising a male connector configured to thread into a light bulb socket, a body extending from the male connector that emits electromagnetic radiation in a 360 degree cylindrical pattern, and a mounting device, shown as a threaded rod, at an opposite end of the body from the male connector. In FIG. 1, the body of the light source comprises a plurality of light emitting diodes (LEDs) that emit electromagnetic radiation (EMR), which is directed outward in a 360 degree cylindrical pattern by one or more reflectors. Alternatively, EMR may be emitted from a fluorescent or halogen bulb. As shown, a blackout disk is disposed between the body of the light source and the mounting device. The blackout disk prevents flares from appearing in images, due to light reflecting from a non-absorbitive (e.g., bright or white) surface, when a camera attached to the mounting device has a very wide field-of-view (e.g., a 3D camera or video recorder).

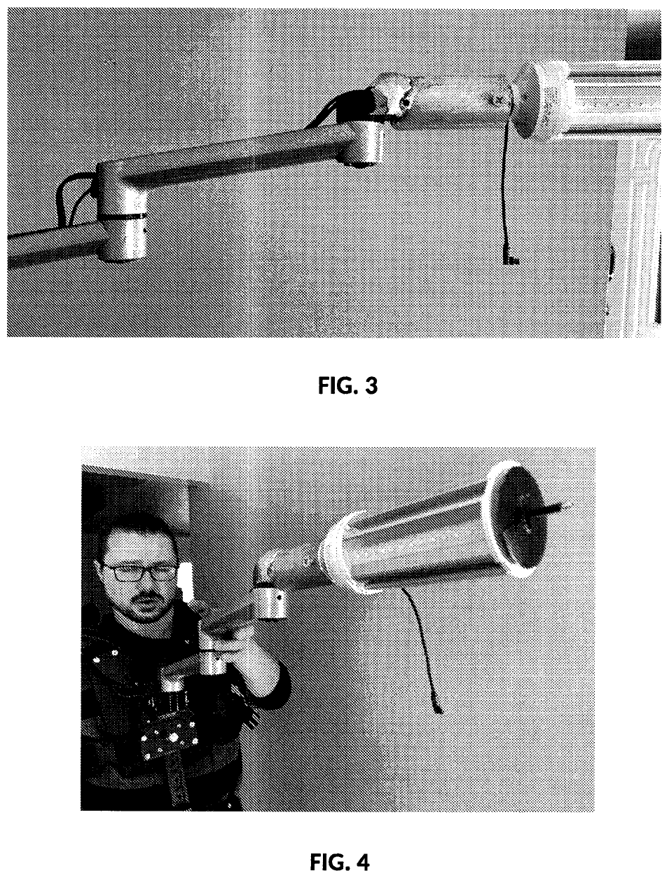

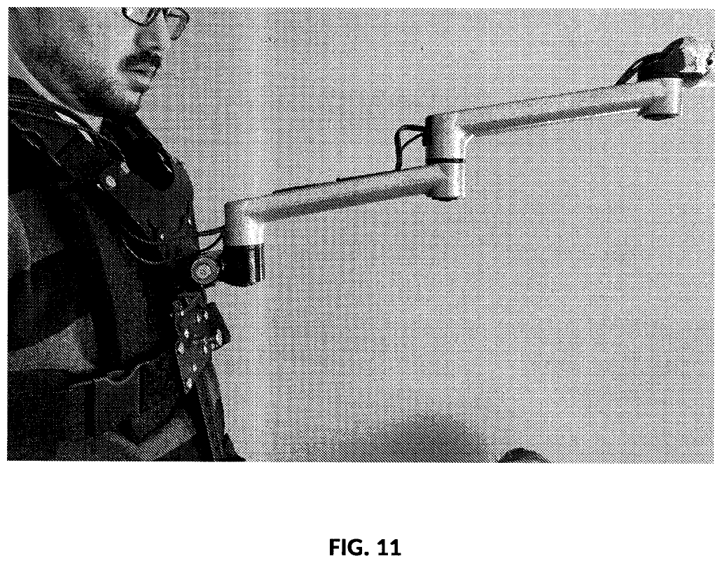

FIG. 2 is a photograph showing a side view of the light source of FIG. 1 attached to a distal end of a device for capturing virtual tour data, according to an embodiment. The male connector of the light source is threaded into a custom end piece comprising a light bulb socket and a pivot joint. In the embodiment shown, a cable is configured for connection to a camera (not shown) that will be attached to the mounting device. The cable is routed through the device and operably connected to an external hard drive, which may for example be housed in a mobile device (see, e.g., FIG. 10). In other embodiments, a camera may contain local data storage (e.g., a memory card of the camera), or the camera may communicate wirelessly with local or remote data storage (e.g., a server on location or cloud storage). FIG. 3 is a photograph showing a side view of the light source of FIG. 1, with internal cabling running through the device, except at pivot points (see also FIG. 11).

FIG. 4 is a photograph showing a perspective end view of the light source of FIG. 1 attached to a distal end of a device for capturing virtual tour data. The blackout disk and mounting device are visible in the foreground. The mounting device, in the form of a threaded rod, may thread directly or indirectly into the base of a camera or video recorder. Other mounting device configurations, such as a clamp, with or without a quick release feature, may directly or indirectly grasp the camera or a base plate attached to the camera.

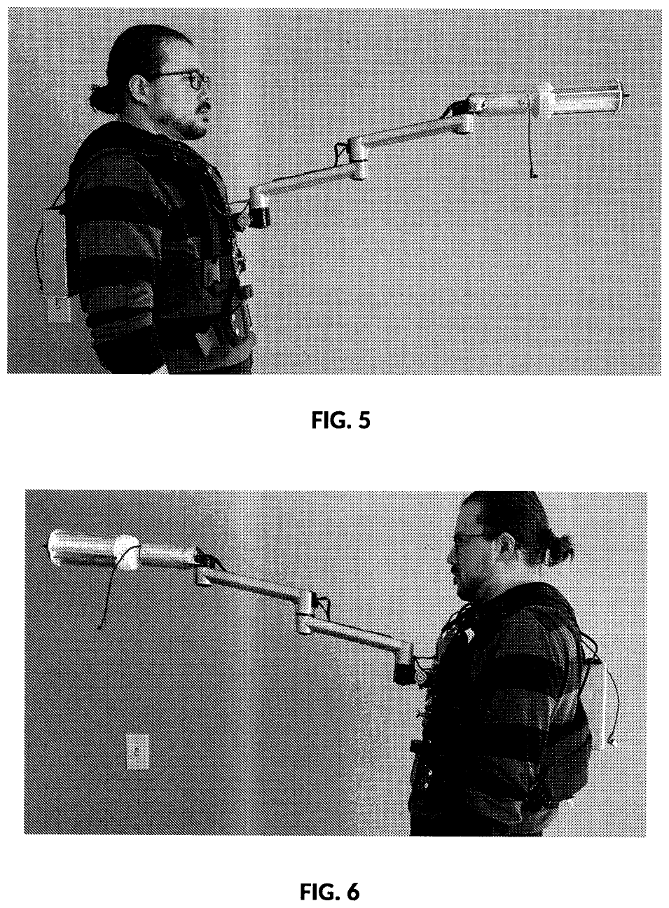

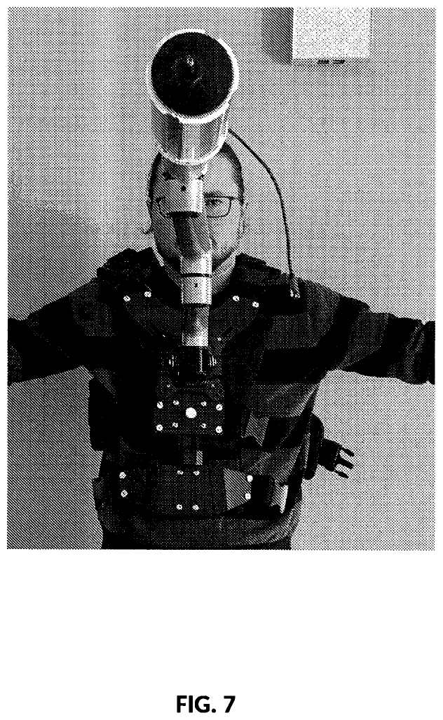

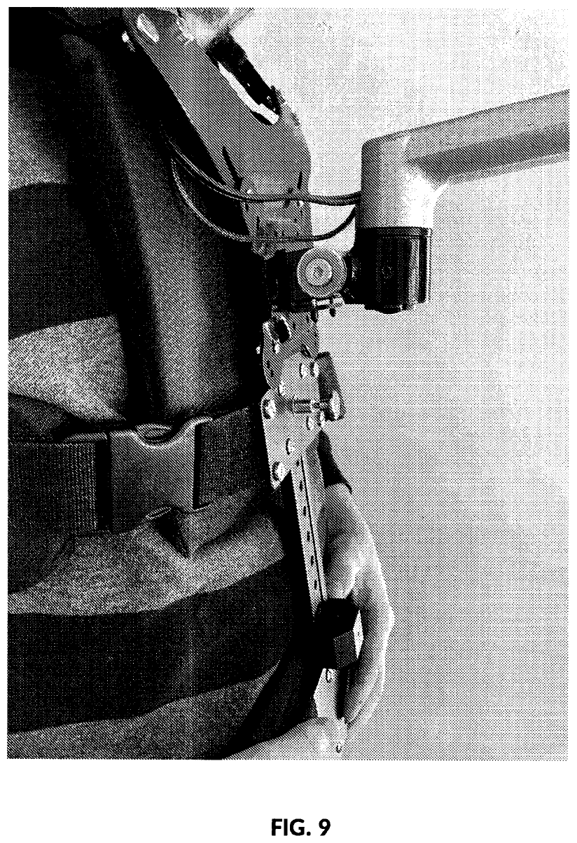

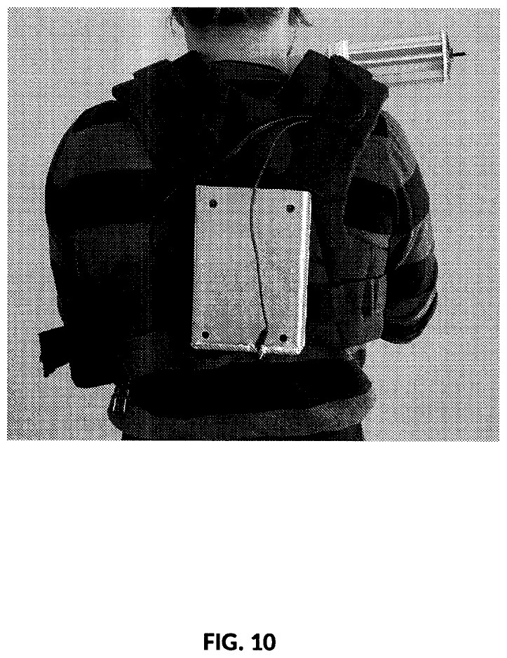

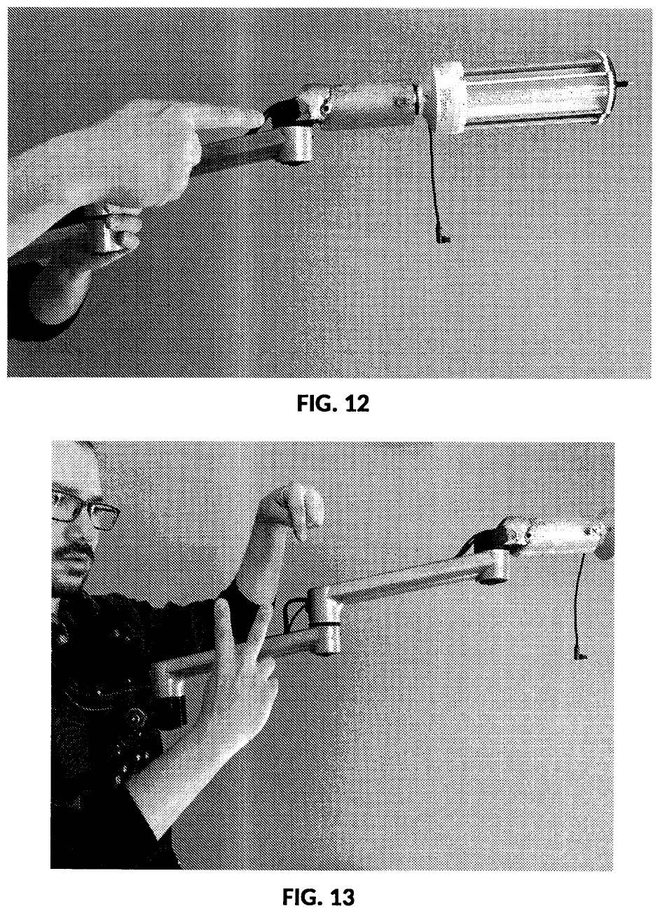

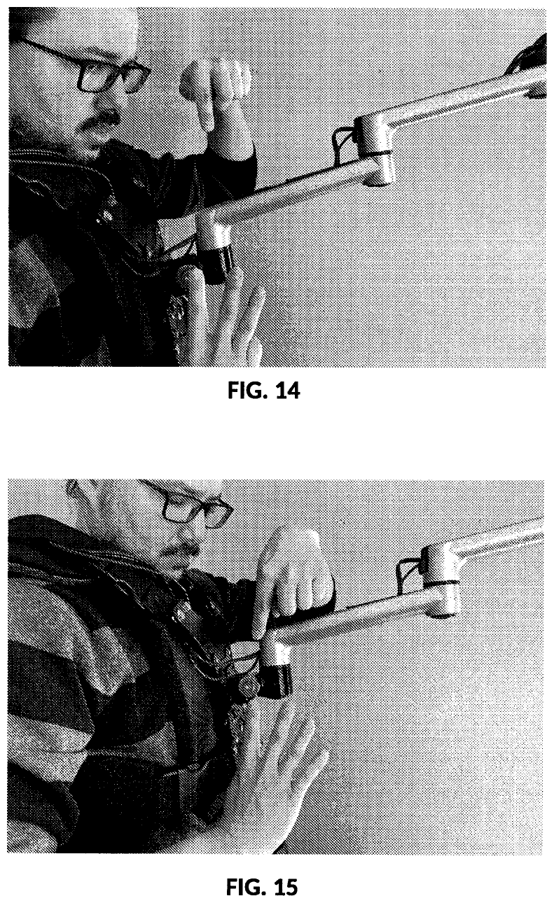

FIG. 5 and FIG. 6 are photographs showing side views of a device for capturing virtual tour data, according to an embodiment. FIG. 7 is a photograph showing a front view of the device of FIGS. 5 and 6. The device comprises a swing arm mounted to a mobile unit (e.g., a vest to be worn by a user), a light source mounted at a distal end of the swing arm, and a camera (not shown) attached to a mounting device of the light source. In the embodiment shown, the mounting device (e.g., threaded post) extends substantially horizontal to a ground surface when the device is in use. Although more or fewer pivot points may be used, the swing arm shown comprises four pivot points (see FIGS. 11, 12, 13, 14 and 15). Two of the four pivot points rotate around axes oriented perpendicular to one another (see FIG. 9), and three of the four pivot points rotate around axes substantially perpendicular to a ground surface when the device is in use. In an embodiment, the device may further include a battery pack providing power to the light source, the camera and/or a data storage system. The battery pack may be housed in a mobile device (see, e.g., FIG. 10).

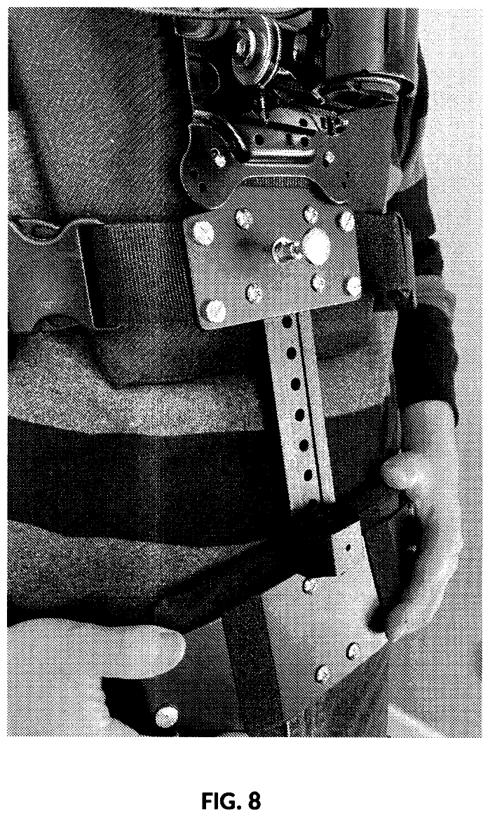

FIG. 8 is a photograph showing details of the front of a vest having a device for capturing virtual tour data mounted thereon. In the embodiment shown, the vest comprises a plurality of pads to be secured to a user and a mechanism for adjusting the torso length, such as a bar with adjustment holes and a locking pin. A base plate of the swing arm is mounted to a plate on the chest area of the vest. FIG. 9 is a photograph showing details of the base plate attachment mechanism and two proximal pivots rotatable perpendicular to one another.

FIG. 10 is a photograph showing details of the back of a vest having a device for capturing virtual tour data mounted thereon. As shown, cables from the camera and/or light source extend to the back of the vest where a battery pack and/or hard drive may be housed in a pocket or container. Positioning the pocket/container on the back of the vest allows it to be out of the way of the swing arm, but other locations for placement of the pocket/container are possible.

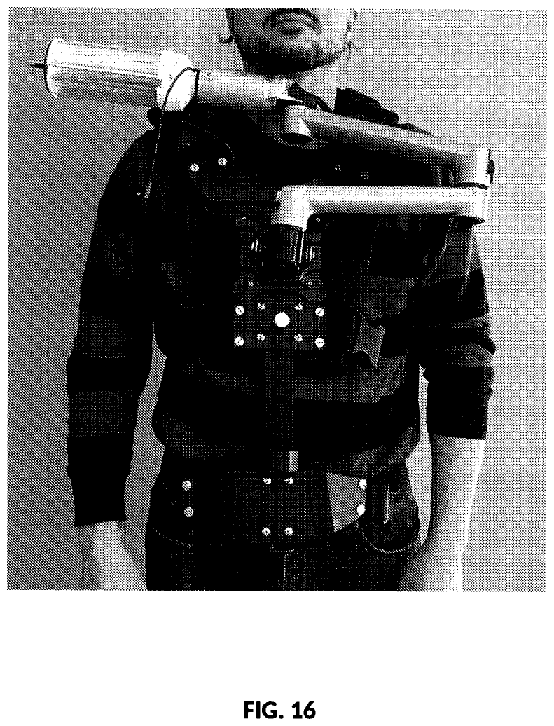

FIG. 16 is a photograph of a device for capturing virtual tour data in a compact configuration, according to an embodiment. The compact configuration allows for easy stowage, and illustrates the extensive range of motion provided by the swing arm.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods, software and apparatus/devices can include a large number of optional elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a pivot” includes a plurality of such pipes and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

What is claimed is:

1. A light source comprising:
a male connector configured to thread into a light bulb socket;
a body extending from the male connector that emits electromagnetic radiation in a 360 degree cylindrical pattern; and
a mounting device at an opposite end of the body from the male connector.

2. The light source of claim 1 further comprising a blackout disk disposed between the body and the mounting device.

3. The light source of claim 2, wherein the blackout disk is a self-supporting object or a coating.

4. The light source of claim 2, wherein the blackout disk is offset from a surface of the body by at least 0.5 cm.

5. A device for capturing virtual tour data, comprising:
a swing arm mounted to a mobile unit;
the light source of claim 1 mounted at a distal end of the swing arm; and
a camera attached to the mounting device.

6. The device of claim 5 further comprising a blackout disk disposed between the body and the mounting device.

7. The device of claim 6, wherein the blackout disk is a self-supporting object or a coating.

8. The device of claim 6, wherein the blackout disk is offset from a surface of the body by at least 0.5 cm.

9. The device of claim 6, wherein the mounting device extends substantially horizontal to a ground surface when the device is in use.

10. The device of claim 6, wherein the swing arm comprises at least four pivot points.

11. The device of claim 10, wherein at least two of the four pivot points rotate around axes oriented perpendicular to one another.

12. The device of claim 10, wherein at least three of the at least four pivot points rotate around axes substantially perpendicular to a ground surface when the device is in use.

13. The device of claim 10, wherein at least one of the at least four pivot points rotates around an axis substantially parallel to a ground surface when the device is in use.

14. The device of claim 5, wherein the mobile unit is a vest to be worn by a user, a helmet to be worn by a user, a manned or un-manned wheeled vehicle, or a manned or un-manned aerial vehicle.

15. The device of claim 5 further comprising a gyroscope.

16. The device of claim 5, wherein a longitudinal axis through the mounting device extends through a center point of a shutter within the camera.

17. The device of claim 5, wherein a processor of the camera operably communicates with a data storage system.

18. The device of claim 5 further comprising a battery pack providing power to the light source, the camera and/or a data storage system.

19. A method of capturing virtual tour data comprising:
providing a swing arm mounted to a mobile unit, the light source of claim 1 mounted at a distal end of the swing arm, and a camera attached to the mounting device;
illuminating the light source; and
capturing images using the camera while the mobile unit moves behind the camera throughout a physical location.

20. The method of claim 19, the virtual tour data is captured at a rate between 50,000 and 1,500,000 square feet per hour
